(19) United States
(12) Patent Application Publication
(10) Pub. No.: US 2008/0030461 A1
(43) Pub. Date: Feb. 7, 2008

(54) MIXED REALITY PRESENTATION APPARATUS AND CONTROL METHOD THEREOF, AND PROGRAM

(75) Inventors: Taichi Matsui, Yokohama-shi (JP); Yasuhiro Okuno, Tokyo (JP)

Correspondence Address: COWAN LIEBOWITZ & LATMAN P.C.;JOHN J TORRENTE, 1133 AVE OF THE AMERICAS, NEW YORK, NY, 10036, US

(73) Assignee: Canon Kabushiki Kaisha, Tokyo (JP)

(21) Appl. No.: 11/830,356

(22) Filed: Jul. 30, 2007

(30) Foreign Application Priority Data
Aug. 1, 2006 (JP) 2006-210255

(51) Int. Cl. G09G 5/00

(52) U.S. Cl. 345/156

(57) ABSTRACT

The pointing position of a pointing device is measured based on position and orientation information of the pointing device. The pointing position is measured based on the pointing position in a sensed image obtained by sensing the pointing position of the pointing device by an image sensing device, and position and orientation information of the image sensing device. A real pointing position of the pointing device is measured based on these measurement results. A virtual pointing device which points to a virtual image to be combined with a real image is generated using the same reference as that used to measure the real pointing position. A virtual pointing position of the virtual pointing device is measured.

### BACKGROUND OF THE INVENTION

1. Field of the Invention

The present invention relates to a mixed reality presentation apparatus and control method thereof, which present an image obtained by combining a virtual image with a real image sensed by an image sensing unit, and a program.

2. Description of the Related Art

In recent years, mixed reality (MR) presentation systems that apply an MR technique which naturally merges the real and virtual worlds have been extensively proposed. These MR presentation systems combine an image of the virtual world (virtual image) rendered by Computer Graphics (CG) with an image of the real world (real image) sensed by an image sensing device such as a camera or the like. The obtained combined image is displayed on a display device such as a Head-Mounted Display (HMD) or the like, thus presenting MR to the system user.

Such MR presentation system must acquire the viewpoint position and orientation of the system user in real time, so as to generate images of the virtual world to follow a change in image of the real world and to enhance the MR. Furthermore, the image must be displayed for the system user on a display device such as an HMD or the like in real time. In such system, a technique for pointing a virtual object included in a virtual image has been proposed (e.g., Japanese Patent Laid-Open No. 2003-296757, corresponding U.S. Pat. No. 7,123,214).

However, no device, which points a virtual image, can also point a real object, and can further measure the pointing position, is available yet.

### SUMMARY OF THE INVENTION

The present invention has been made to solve the aforementioned problems, and has as its object to provide a mixed reality presentation apparatus and control method thereof, which allow to manipulate a virtual image and real image using one pointing device, and a program.

According to the first aspect of the present invention, a mixed reality presentation apparatus which combines a virtual image with a real image sensed by an image sensing device, and presents a combined image, comprising:

first measurement means for measuring a pointing position of a pointing device based on position and orientation information of the pointing device;

second measurement means for measuring the pointing position based on a pointing position in a sensed image obtained by sensing the pointing position of the pointing device by the image sensing device, and position and orientation information of the image sensing device;

real pointing position measurement means for measuring a real pointing position of the pointing device based on the measurement results of the first measurement means and the second measurement means;

generation means for generating a virtual pointing device that points to a virtual image to be combined with the real image using the same reference as a reference used to measure the real pointing position; and

virtual pointing position measurement means for measuring a virtual pointing position of the virtual pointing device.

In a preferred embodiment, the apparatus further comprises display means for combining and displaying the real image and the virtual image based on the measurement results of the real pointing position measurement means and the virtual pointing position measurement means.

In a preferred embodiment, the display means further displays an index indicating the virtual pointing position on the virtual image.

In a preferred embodiment, the second measurement means measures the pointing position based on pointing positions in sensed images obtained by sensing the pointing position of the pointing device by a plurality of image sensing devices and a plurality of position and orientation information of the plurality of image sensing devices.

In a preferred embodiment, apparatus further comprises calculation means for acquiring position information indicating the real pointing position and position information indicating the virtual pointing position and calculating a distance between the real pointing position and the virtual pointing position.

In a preferred embodiment, the apparatus further comprises:

determination means for determining whether or not the virtual image exists in a pointing direction of the virtual pointing device; and

control means for controlling driving of the pointing device and display of an index indicating the virtual pointing position based on the determination result of the determination means.

In a preferred embodiment, when the virtual image exists in the pointing direction of the virtual pointing device as a result of determination of the determination means, the driving of the pointing device is stopped, and the index indicating the virtual pointing position is displayed on the virtual image.

In a preferred embodiment, when the virtual image does not exist in the pointing direction of the virtual pointing device as a result of determination of the determination means, the pointing device is driven, and the index indicating the virtual pointing position is inhibited from being displayed.

In a preferred embodiment, when the virtual image does not exist in the pointing direction of the virtual pointing device as a result of determination of the determination means, the pointing device is driven, and the index indicating the virtual pointing position is displayed to have a display pattern different from a display pattern of the index indicating the virtual pointing position when the virtual image exists in the pointing direction of the virtual pointing device.

According to the second aspect of the present invention, a method of controlling a mixed reality presentation apparatus which combines a virtual image with a real image sensed by an image sensing device, and presents a combined image, the method comprising:

a first measurement step of measuring a pointing position of a pointing device based on position and orientation information of the pointing device;

a second measurement step of measuring the pointing position based on a pointing position in a sensed image obtained by sensing the pointing position of the pointing device by the image sensing device, and position and orientation information of the image sensing device;

a real pointing position measurement step of measuring a real pointing position of the pointing device based on the measurement results in the first measurement step and the second measurement step;

a generation step of generating a virtual pointing device that points to a virtual image to be combined with the real image using the same reference as a reference used to measure the real pointing position; and

a virtual pointing position measurement step of measuring a virtual pointing position of the virtual pointing device.

According to the third aspect of the present invention, a computer program which is stored in a computer-readable medium to make a computer execute control of a mixed reality presentation apparatus that combines a virtual image with a real image sensed by an image sensing device and presents a combined image, the computer program characterized by making the computer execute:

a first measurement step of measuring a pointing position of a pointing device based on position and orientation information of the pointing device;

a second measurement step of measuring the pointing position based on a pointing position in a sensed image obtained by sensing the pointing position of the pointing device by the image sensing device, and position and orientation information of the image sensing device;

a real pointing position measurement step of measuring a real pointing position of the pointing device based on the measurement results in the first measurement step and the second measurement step;

a generation step of generating a virtual pointing device that points to a virtual image to be combined with the real image using the same reference as a reference used to measure the real pointing position; and

a virtual pointing position measurement step of measuring a virtual pointing position of the virtual pointing device.

According to the fourth aspect of the present invention, a mixed reality presentation apparatus which combines a virtual image with a real image sensed by an image sensing device, and presents a combined image, comprising:

measurement means for measuring a position and orientation of a pointing device which has a light-emitting unit used to point to a three-dimensional position;

determination means for determining based on the position and orientation measured by the measurement means whether or not the pointing device points to a virtual object; and

control means for controlling the light-emitting unit of the pointing device based on the determination result of the determination means.

In a preferred embodiment, the pointing device further comprises:

a switch for controlling driving of itself; and

display control means for controlling display of a virtual pointing device based on the determination result of the determination means, and

the determination means further determines whether the switch is ON or OFF.

In a preferred embodiment,

1) when the switch is OFF as a result of determination by the determination means, the control means sets the driving of the pointing device to OFF, and the display control means sets the display of the virtual pointing device to OFF,

2) when the switch is ON and the pointing device points to the virtual object as a result of determination by the determination means, the display control means sets the display of the virtual pointing device to ON, and the control means sets the driving of the pointing device to OFF, and

3) when the switch is ON and the pointing device does not point to the virtual object as a result of determination by the determination means, the control means sets the driving of the pointing device to ON, and the display control means sets the display of the virtual pointing device to OFF.

According to the fifth aspect of the present invention, a method of controlling a mixed reality presentation apparatus which combines a virtual image with a real image sensed by an image sensing device, and presents a combined image, the method comprising:

a measurement step of measuring a position and orientation of a pointing device which has a light-emitting unit used to point to a three-dimensional position;

a determination step of determining based on the position and orientation measured in the measurement step whether or not the pointing device points to a virtual object; and

a control step of controlling the light-emitting unit of the pointing device based on the determination result in the determination step.

According to the sixth aspect of the present invention, a computer program, stored in a computer-readable medium, for making a computer execute control of a mixed reality presentation apparatus which combines a virtual image with a real image sensed by an image sensing device, and presents a combined image, the computer program characterized by making the computer execute:

a measurement step of measuring a position and orientation of a pointing device which has a light-emitting unit used to point to a three-dimensional position;

a determination step of determining based on the position and orientation measured in the measurement step whether or not the pointing device points to a virtual object; and

a control step of controlling the light-emitting unit of the pointing device based on the determination result in the determination step.

Further features of the present invention will become apparent from the following description of exemplary embodiments with reference to the attached drawings.

### BRIEF DESCRIPTION OF THE DRAWINGS

FIG. 1 is a block diagram showing the arrangement of an MR presentation system according to the first embodiment of the present invention;

FIG. 2 is a view for explaining a manipulation example of the MR presentation system according to the first embodiment of the present invention;

FIG. 3 is a view for explaining a manipulation example of the MR presentation system according to the first embodiment of the present invention;

FIG. 4 is a view for explaining a manipulation example of the MR presentation system according to the first embodiment of the present invention;

FIG. 5 is a flowchart showing the processing to be executed by the MR presentation system according to the first embodiment of the present invention;

FIG. 6 is a block diagram showing the arrangement of an MR presentation system according to the second embodiment of the present invention;

FIG. 7 is a view showing the detailed arrangement of a pointing device according to the second embodiment of the present invention;

FIG. 8 is a flowchart showing the processing to be executed by the MR presentation system according to the second embodiment of the present invention;

FIG. 9 is a view for explaining a use example of a conventional MR presentation apparatus;

FIGS. 10A and 10B are views for explaining a use example of the conventional MR presentation apparatus; and

FIG. 11 is a view for explaining a use example of the MR presentation apparatus.

### DESCRIPTION OF THE EMBODIMENTS

Preferred embodiments of the present invention will now be described in detail with reference to the drawings. It should be noted that the relative arrangement of the components, the numerical expressions and numerical values set forth in these embodiments do not limit the scope of the present invention unless it is specifically stated otherwise.

An MR presentation system sets the viewpoint position and orientation of the user, which are measured by a sensor device, as a virtual viewpoint position and orientation on the virtual world, renders an image of the virtual world (virtual image) by CG based on the settings, and combines the virtual image with an image of the real world (real image).

Since an HMD (Head-Mounted Display) is used to present MR, the visual field of the user of the MR presentation system includes a display of a display device of the HMD, which includes a region where the virtual image is rendered. Hence, the user of the MR presentation system can observe an image as if a virtual object were present on the real world. Furthermore, in the MR world, the virtual image can be combined with (superimposed on) the real image. The user can measure the real image with an appearance of the virtual image using a virtual pointing device.

In this way, the MR presentation system comprises a real image sensing unit which senses a real image, a virtual image generation unit which generates a virtual image viewed from the position and orientation of the real image sensing unit, and an image display unit which combines and displays these images. Furthermore, the MR presentation system comprises a viewpoint position and orientation detection unit (e.g., position and orientation sensor) which detects the viewpoint position and direction of the real image sensing unit so as to correctly display the positional relationship between the virtual image and real image even when the position and orientation of the viewpoint of the real image sensing unit changes.

The real image sensing unit used to sense an image of the real world comprises, e.g., a video camera. The real image sensing unit senses a real space in the viewpoint direction of the camera, and captures the sensed image in a memory.

The virtual image generation unit places a virtual image (e.g., a CG that has undergone three-dimensional (3D) modeling) on a virtual space having the same scale (reference) as that of the real space, and renders the virtual image as that observed from the viewpoint position and direction detected by the viewpoint position and orientation detection unit.

When this virtual image is combined with the real image sensed by the real image sensing unit, an image which seems as if the virtual image (CG object) were laid out in the real image when observed from every viewpoint position and direction can be displayed consequently.

Changes in type and layout, animation, and the like of a CG used as the virtual image can be freely done by the same method as in a general CG. Another position and orientation sensor may be equipped to designate the position and orientation of a CG, and the CG can be rendered at the position indicated by the values of the position and orientation sensor. With this arrangement, like in the conventional system, the observer holds the position and orientation sensor in his or her hand, and observes a CG while designating, using that position and orientation sensor, the position and orientation where the CG is to be displayed.

As an image display device which combines and displays the real image and virtual image, for example, an HMD is used, as described above. When the observer wears the HMD in place of a normal monitor, and the real image sensing unit is attached in the viewpoint direction of the HMD, the HMD can display an image in a direction in which the observer faces. Also, since the virtual image when the observer faces that direction can also be rendered, the sense of immersion the observer experiences can be enhanced.

As the viewpoint position and orientation detection unit, for example, a magnetic position and orientation sensor or the like is used. By attaching such position and orientation sensor to the video camera as a real image sensing unit (or an HMD on which the video camera is attached), the position and orientation information of the viewpoint can be detected.

With this arrangement, the observer can observe an image obtained by combining the real image and virtual image via the image display unit such as an HMD or the like. When the observer takes a look around, the real image sensing unit (video camera) attached to the HMD senses a real image, and the viewpoint position and orientation detection unit (position and orientation sensor) attached to the HMD detects the position and viewpoint direction of the video camera. The virtual image generation unit renders a virtual image viewed from that viewpoint position and orientation, and combines it with the real image, thus displaying a combined image on the image display unit.

Preferred embodiments of the present invention will be described in detail hereinafter with reference to the accompanying drawings.

### First Embodiment

The first embodiment implements an arrangement which allows the user to seamlessly point and measure a virtual object and real object in the MR world using a single pointing device.

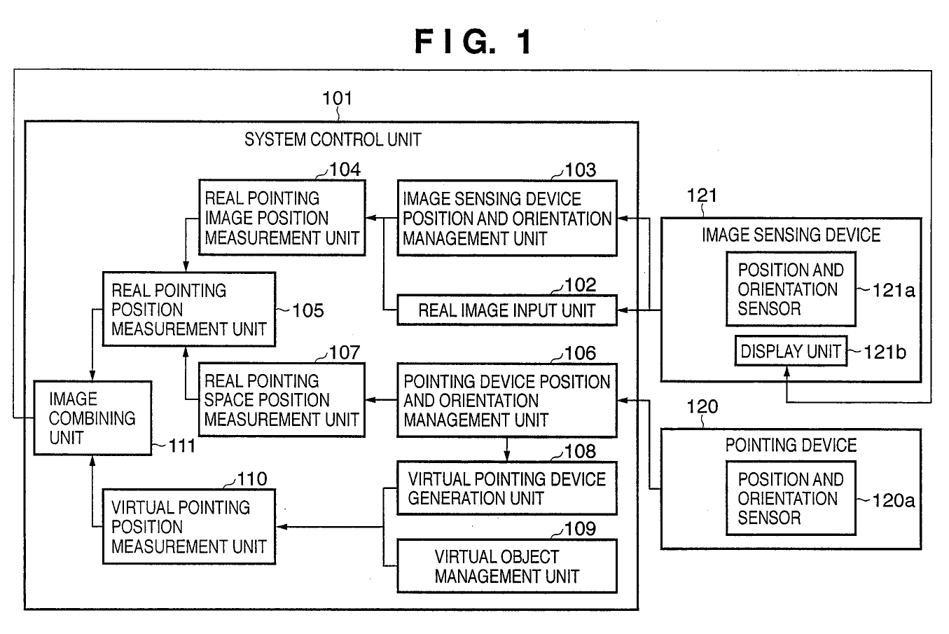

The arrangement of the MR presentation system will be described below with reference to FIG. 1.

FIG. 1 is a block diagram showing the arrangement of an MR presentation system according to the first embodiment of the present invention.

The MR presentation system comprises a system control unit 101, an image sensing device 121, and a pointing device 120.

This system control unit 101 comprises a real image input unit 102, an image sensing device position and orientation management unit 103, a real pointing image measurement unit 104, and a real pointing position measurement unit 105. Also, this system control unit 101 comprises a pointing device position and orientation management unit 106, a real pointing space position measurement unit 107, a virtual pointing device generation unit 108, a virtual object management unit 109, a virtual pointing position measurement unit 110, and an image combining unit 111.

Note that the system control unit 101 can be implemented by, e.g., a personal computer such as a general-purpose computer or the like. This personal computer has standard building components (e.g., a CPU, RAM, ROM, hard disk, external storage device, network interface, display, keyboard, mouse, and the like) equipped in a general-purpose computer. The CPU of this general-purpose computer reads out and executes various programs such as control programs and the like stored in the RAM and ROM, thus implementing respective building components of the system control unit 101. Of course, all or at least some of the building components of the system control unit 101 may be implemented by hardware.

The pointing position measurement of a real object will be described below.

The pointing device 120 is used to point to a real object based on a predetermined reference. The pointing device 120 is set at a predetermined position and orientation, or it is movable but its position and orientation are always measured. In either state, the position and orientation information indicating the position and orientation of the pointing device 120 is managed by the pointing device position and orientation management unit 106.

When the pointing device 120 is movable, it incorporates a position and orientation sensor 120a used to detect the self position and orientation information, and that position and orientation information is transmitted to the pointing device position and orientation management unit 106.

The pointing device position and orientation management unit 106 transmits the position and orientation information of the pointing device 120 to the real pointing space position measurement unit 107. The real pointing space position measurement unit 107 limits a pointing position based on the position and orientation information of the pointing device 120 and a predetermined reference (e.g., an XYZ coordinate system) to which the pointing device 120 points. For example, the unit 107 limits the pointing position to those on a straight line if the pointing device 120 is a laser pointer. This is called a primary measurement process. The real pointing space position measurement unit 107 transmits the primary measurement process result to the real pointing position measurement unit 105.

The image sensing device 121 is set at a predetermined position and orientation, or it is movable but its position and orientation are always measured. In either state, the position and orientation information indicating the position and orientation of the image sensing device 121 is managed by the image sensing device position and orientation management unit 103.

When the image sensing device 121 is movable, it incorporates a position and orientation sensor 121a used to detect the self position and orientation information, and that position and orientation information is transmitted to the image sensing device position and orientation management unit 103.

The image sensing device position and orientation management unit 103 transmits the position and orientation information of the image sensing device 121 to the real pointing image position measurement unit 104. The image sensing device 121 senses the pointing position of the pointing device 120, and transmits the obtained sensed image to the real image input unit 102. The real image input unit 102 temporarily stores the input sensed image as a real image in a real image memory (not shown), and transmits the sensed image to the real pointing image position measurement unit 104.

The real pointing image position measurement unit 104 measures the pointing position of the pointing device 120 from the sensed image. The measurement method is implemented based on the feature amounts such as the color, shape, display form, and the like output from the pointing device 120. For example, if the pointing device marks a red point on an object, that red point is detected from the sensed image. Since the process for detecting a specific color from the sensed image is a state-of-the-art technique, a detailed description thereof will not be given.

The pointing position is limited by that in the sensed image and the position and orientation information of the image sensing device 121. This is called a secondary measurement process. The real pointing image position measurement unit 104 transmits the secondary measurement result to the real pointing position measurement unit 105.

The real pointing position measurement unit 105 measures a real pointing position of the pointing device 120 by the triangulation method by combining the primary and secondary measurement process results.

The pointing position measurement of a virtual object will be described below.

The pointing device position and orientation management unit 106 transmits the position and orientation information of the pointing device to the virtual pointing device generation unit 108.

The virtual pointing device generation unit 108 generates a virtual pointing device which points to the virtual world (virtual object) based on the same reference as that of a real pointing device (the pointing device 120). The same reference means that if the real pointing device is a laser pointing device and an emitted laser beam points to a real object on a straight line, the virtual point device similarly points to a virtual object in the same direction from the same start point as those of the real pointing device.

The virtual pointing device generation unit 108 generates this virtual pointing device, and transmits the start point and pointing direction in the virtual world of the virtual pointing device to the virtual pointing position measurement unit 110. The virtual object management unit 109 manages the structure of the virtual world (e.g., a virtual image indicating a virtual object), and transmits the managed structure to the virtual pointing position measurement unit 110.

The virtual pointing position measurement unit 110 measures where the virtual pointing device points to based on the managed structure of the virtual world and the start point and direction of the virtual pointing device.

Generation of an MR image based on the pointing position measurement result of the real object and that of the virtual object will be described below.

As described above, the real pointing position measurement unit 105 measures the real pointing position in the sensed image, and the virtual pointing position measurement unit 110 measures the virtual pointing position. Since these pointing positions are managed based on the same reference (coordinate system), the image combining unit 111 can determine to which position in the image, which is displayed on a display unit 121b and includes the real image and the virtual image, the pointing position belongs.

For this reason, when the pointing device 120 points to a real object, its real pointing position is displayed on the real object displayed on the display unit 121b. On the other hand, when the pointing device 120 points to a virtual object, it is switched to the virtual pointing device, and the virtual pointing position on the virtual object is displayed on the virtual object displayed on the display unit 121b.

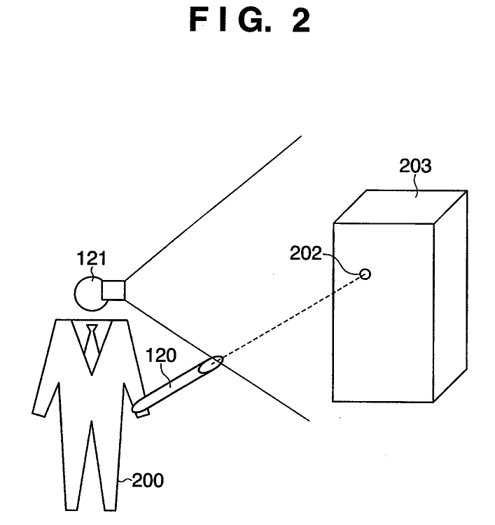

Practical manipulation examples will be described below with reference to FIGS. 2 to 4.

FIGS. 2 to 4 are views for explaining manipulation examples of the MR presentation system according to the first embodiment of the present invention.

FIG. 2 illustrates a state in which a user 200 holds the pointing device 120 (e.g., a laser pointing device) and points to a real object 203. The pointing device 120 points to a point 202 on the real object 203. In this case, the user 200 observes the state shown in FIG. 2 via the display unit 121b of the image sensing device 121.

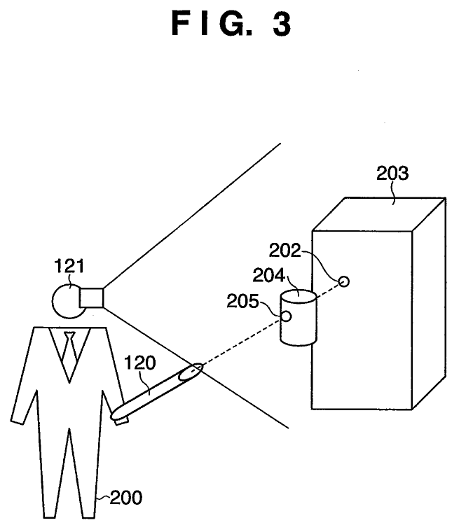

FIG. 3 shows a state in which a virtual object 204 is laid out in the state in FIG. 2. The virtual object 204 exists between the user 200 and the real object 203. The virtual pointing device is implemented on the pointing device 120, and points to a point 205 on the virtual object 204. In this case, the user 200 observes the state in FIG. 3 via the display unit 121b of the image sensing device 121.

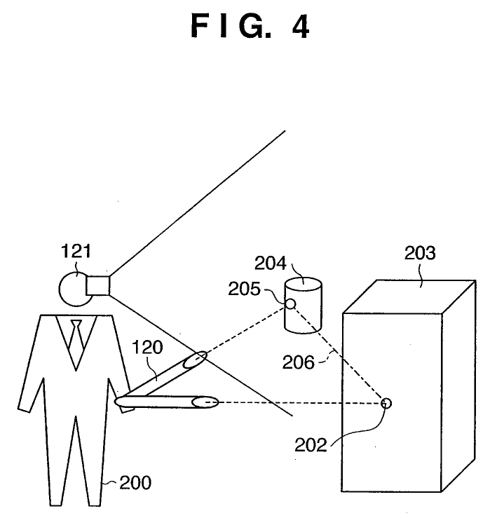

FIG. 4 illustrates a state in which the user 200 holds the pointing device 120, points to the point 202 on the real object 203, then moves the pointing device 120, and points to the point 205 on the virtual object 204. In this case, the user 200 observes the state in FIG. 4 via the display unit 121b of the image sensing device 121.

In this state, the user 200 can move the pointing position from, e.g., the real object 203 to the virtual object 204. That is, when the pointing position moves from the point 202 on the real object 203 to the point 205 on the virtual object 204, the real pointing position (point 202) of the real pointing device moves to the virtual pointing position (point 205) of the virtual pointing device.

More specifically, when the real pointing position of the pointing device 120 enters (belongs to) an image region indicating the virtual object, the system control unit 101 switches the pointing device to the virtual pointing device. Then, the virtual pointing position by this virtual pointing device is displayed on the virtual object.

As described above, according to the first embodiment, since the point (real pointing position) 202 on the real object 203 and the point (virtual pointing position) 205 on the virtual object 204 can be detected, a distance 206 between these two points can be detected. More specifically, the position information of the real pointing position 202 and that of the virtual pointing position 205 are stored in a memory, and the distance 206 between these positions can be calculated based on these position information.

When the position information is stored in the memory, for example, a position information input unit such as a dedicated switch or the like is provided to the pointing device, and the position information to which the pointing device 120 points is input upon detection of an operation of this position information input unit.

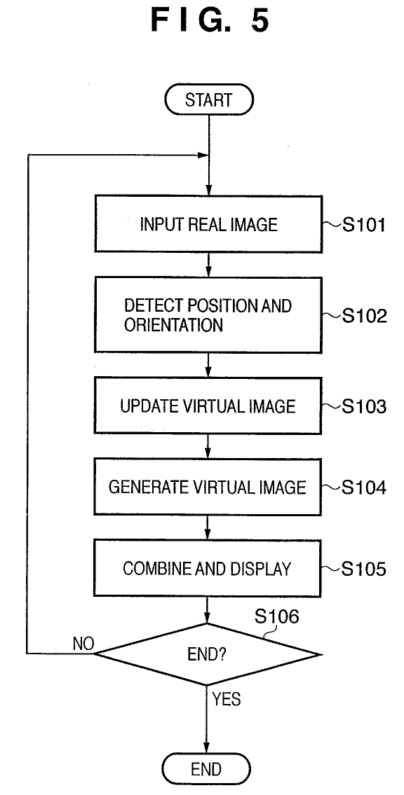

The processing to be executed by the MR presentation system according to the first embodiment will be described below with reference to FIG. 5.

FIG. 5 is a flowchart showing the processing to be executed by the MR presentation system according to the first embodiment of the present invention.

Note that the processing in FIG. 5 is implemented when the CPU of the system control unit 101 reads out a program stored in the ROM and executes the readout program.

In step S101, the real image input unit 102 inputs a real image. Note that the real image input unit 102 senses and inputs an image using the image sensing device 121, and stores that sensed image in the real image memory (not shown) as a real image.

In step S102, the image sensing device position and orientation management unit 103 and pointing device position and orientation management unit 106 respectively detect the position and orientation information of the image sensing device 121 and that of the pointing device 120. These information are stored in a memory (not shown).

In step S103, a virtual image is updated. In this case, the position and orientation of the virtual pointing device are updated based on the position and orientation information of the pointing device 120.

In step S104, the virtual pointing position measurement unit 110 stores the virtual image including the virtual object image and virtual pointing device in a virtual image memory (not shown). In this case, the virtual image viewed from the position and orientation of the image sensing device 121 indicated by the position and orientation information of the image sensing device 121 is rendered and is stored in the virtual image memory.

Especially, based on the position and orientation information of the pointing device 120 and that of the image sensing device 121, when the pointing device 120 points to the virtual image, the virtual pointing device is generated. Then, an index image which indicates the virtual pointing position on that virtual image is generated, and is stored in the virtual image memory.

In step S105, the image combining unit 111 displays an MR image obtained by combining the real image stored in the real image memory and the virtual image stored in the virtual image memory on the display unit 121b. This processing is the same as that executed in the conventional MR presentation system.

It is then checked in step S106 if the processing is to end. If the processing is to end (YES in step S106), the MR image presentation processing ends. On the other hand, if the processing is not to end (NO in step S106), the process returns to step S101. As a result, the MR image can be presented as a continuous moving image.

When the image sensing device 121 allows stereoscopic display, stereoscopic images can be generated by repeating the processing in FIG. 5 for the viewpoints of the right and left eyes (in this case, the image sensing device 121 is required for each of right and left displays). Of course, depending on the arrangements, two or more image sensing devices may be used. As the processing for the arrangement using a plurality of image sensing devices, the processing in FIG. 5 is executed for each image sensing device.

As described above, according to the first embodiment, the user of the MR presentation system can simultaneously measure the positions of the real object and virtual object using a single pointing device during MR experience. As a result, the distance between the positions of the real object and virtual object can be measured.

### Second Embodiment

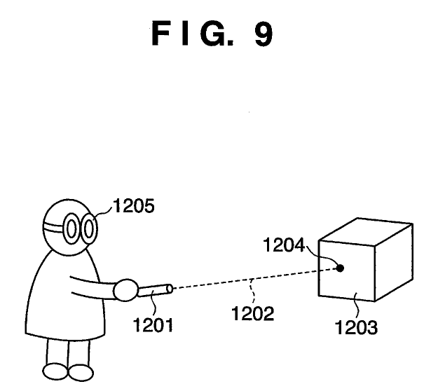

Prior to a description of the second embodiment, a use example of a conventional MR presentation apparatus will be explained with reference to FIG. 9.

An observer who wears an HMD 1205 holds a pen-shaped position and orientation sensor 1201 in his or her hand. This pen-shaped position and orientation sensor 1201 has a switch. As the pen-shaped position and orientation sensor, for example, stylus ST8 available from Polhemus, U.S.A. is known.

In this example of the MR presentation apparatus, upon pressing the switch, a beam CG 1202 is rendered from the tip of the pen-shaped position and orientation sensor 1201. This beam CG 1202 imitates a laser beam of a real laser pointing device as a virtual CG. By displaying the beam CG 1202 until it hits a virtual CG object 1203, it is possible to make the beam CG 1202 look as if it points to the CG object 1203.

Note that hit determination of the beam CG 1202 and CG object 1203 can be attained by the conventional technique. In order to allow easy recognition of the position where the beam CG 1202 hits the CG object 1203, a pointing mark (index) CG 1204 (a painted circle in FIG. 9) may be rendered at that position. Alternatively, only the pointing mark CG 1204 may be rendered without rendering any linear CG like the beam CG 1202.

The aforementioned system can be implemented by the technique of the conventional MR presentation system.

A device called a laser pointer, which points to a real object by a laser beam is commercially available.

However, in the conventional system, the pointing mark CG 1204 shown in FIG. 9 is displayed at the hit position on the CG object 1203. For this reason, when the beam CG 1202 hits the CG object 1203, the pointing mark CG 1204 can point to the object CG 1203.

However, the MR presentation apparatus presents a virtual CG object while combining it with real objects (wall and floor of a room, a person, and the like). The beam CG 1202 and pointing mark CG 1204 shown in FIG. 9 can point to the virtual object CG but cannot point to a real object.

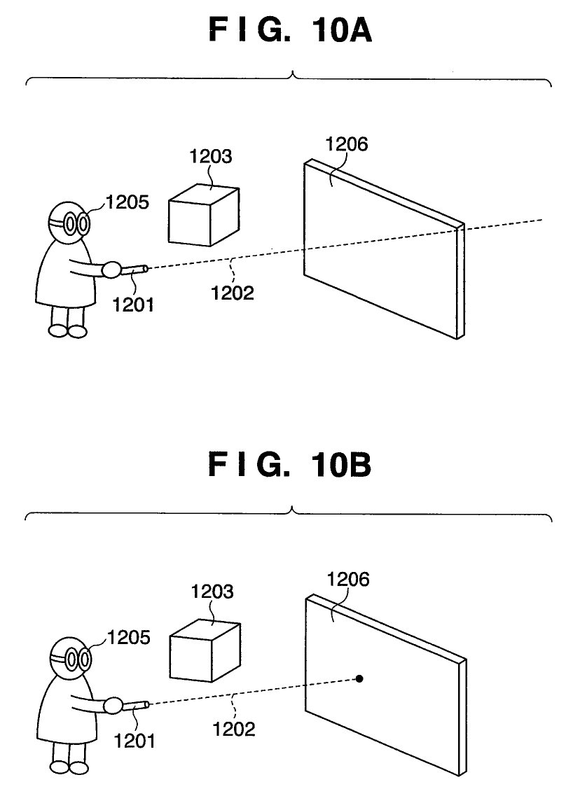

As shown in FIG. 10A, when the beam CG 1202 does not hit the CG object 1203, how far the beam CG 1202 is to be extended cannot be determined. In the example of FIG. 10A, the hit determination of a real object 1206 and the beam CG 1202 is not made. For this reason, as shown in FIG. 10A, the beam CG 1202 is rendered as if it shot through the real object 1203.

To solve this problem, if it is possible to make the hit determination of the beam CG 1202 and real object 1206, the beam CG 1202 can correctly point to the real object, as shown in FIG. 10B. In order to allow this hit determination, an arrangement that detects the shape and the position and orientation of a real object must be added. However, real objects are not always fixed like the wall, but may be movable (e.g., a person or the like). Hence, the position and orientation of a real object must be dynamically detected, and a large-scale apparatus is required for this purpose.

Hence, in order to solve this problem, the first embodiment has explained the arrangement that combines a virtual pointing device and a real pointing device. With this arrangement, the virtual laser pointing device displays only the pointing mark CG on the CG object (it does not display any laser beam).

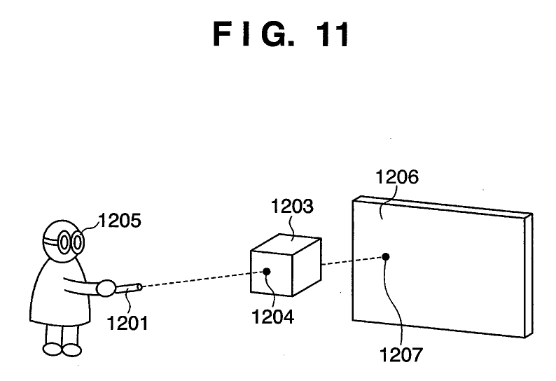

With this arrangement a real laser beam points to a real object, and a virtual laser pointer can point to a virtual object by means of the pointing mark CG. However, as shown in FIG. 11, the pointing mark CG 1204 is displayed on the CG object 1203. However, in this situation, since a real pointing position 1207 of the real pointing device is not occluded by the CG object 1203, it is generated on the real object 1206 behind the CG object 1203. In this manner, with the arrangement of the first embodiment, the operator's intention cannot often be correctly conveyed.

Hence, the second embodiment will explain an arrangement obtained by improving that of the first embodiment.

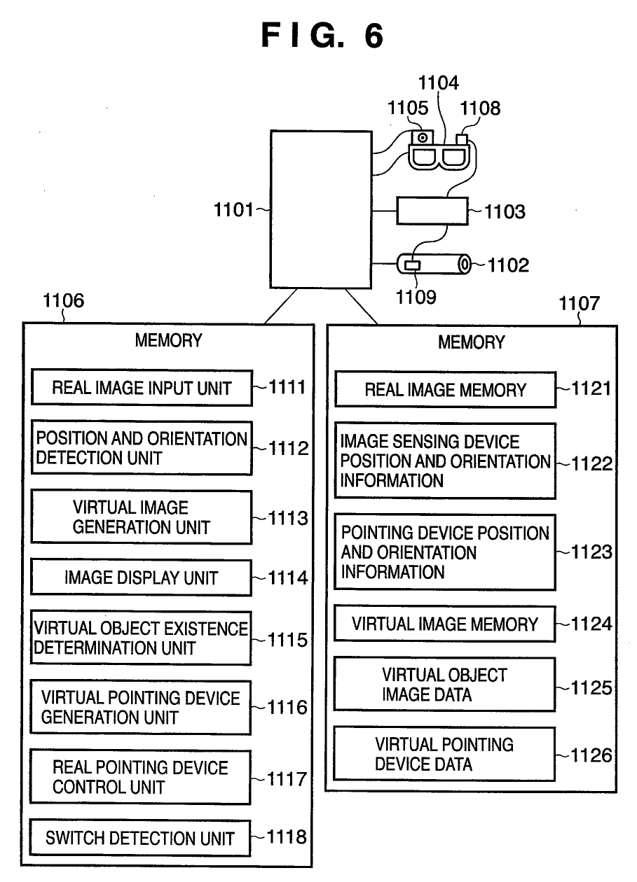

FIG. 6 is a block diagram showing the arrangement of the MR presentation system according to the second embodiment of the present invention.

Especially, FIG. 6 shows an arrangement for presenting MR per observer.

In the arrangement shown in FIG. 6, a pointing device 1102, a position and orientation sensor controller 1103, a HMD 1104, an image sensing device (e.g., video camera) 1105, and memories 1106 and 1107 are connected to a PC (personal computer) 1101.

Assume that the PC 1101 includes a video output device (video card) used to output an image to the HMD 1104, and a video capture device (video capture card) used to capture an image of the image sensing device 1105. The HMD 1104 is connected to the video output device, and the image sensing device 1105 is connected to the video capture device.

The position and orientation sensor controller 1103 is connected to an interface of the PC 1101. This interface includes, e.g., a USB interface and serial port. Position and orientation sensors 1108 and 1109 are connected to the position and orientation sensor controller 1103. The position and orientation sensor 1108 is mounted on the HMD 1104, and is used to detect the viewpoint position and orientation of the image sensing device 1105 mounted on the HMD 1104. The position and orientation sensor 1109 is attached to the pointing device 1102, and is used to detect the position and orientation of the pointing device 1102.

The memories 1106 and 1107 are connected to a bus of the PC 1101. The memories 1106 and 1107 may be physically different real memories, or may be locally assured on a single real memory.

Virtual images to be rendered in the second embodiment are stored in the memory 1107 of the PC 1101 as virtual object image data 1125 and virtual pointing device data 1126. The virtual pointing device data 1126 is a laser beam CG which imitates a laser beam. Assume that the position and orientation of this virtual pointing device data 1126 are controlled by the position and orientation sensor 1109 mounted on the pointing device 1102, and they are manipulated to always extend forward from the tip of the pointing device 1102. The virtual images to be displayed in the second embodiment are the virtual object image data 1125 and the virtual pointing device data 1126.

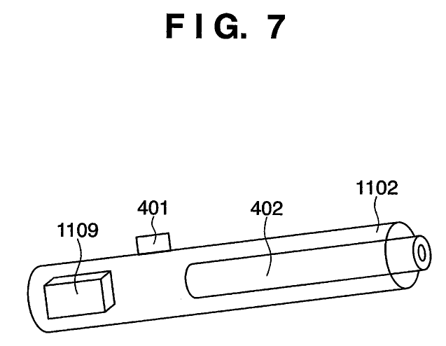

The detailed arrangement of the point device 1102 in FIG. 6 will be described below with reference to FIG. 7.

FIG. 7 is a view showing the detailed arrangement of the pointing device according to the second embodiment of the present invention.

The pointing device 1102 comprises a real laser pointer 402 as a real pointing unit, the position and orientation sensor 1109, and a switch 401. The switch 401 is connected to the PC 1101, and its ON/OFF state can be detected by a switch detection unit 1118 in FIG. 6. Since this switch detection unit 1118 is a generally known technique as a controller for games and the like, a detailed description thereof will not be given.

The laser pointer 402 is connected to the PC 1101, and ON/OFF of its emission can be controlled by a real pointing device control unit 1117 in FIG. 6. The driving of the laser pointer 402 is controlled by turning on/off the switch 401. Since a technique for this control is generally known, a detailed description thereof will not be given.

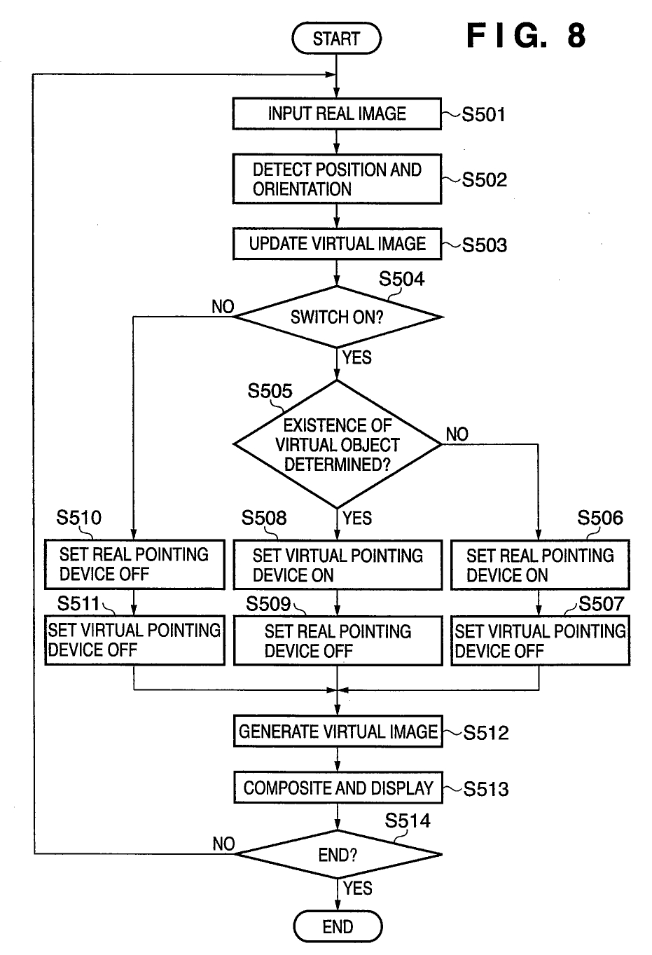

The processing to be executed by the MR presentation system according to the second embodiment will be described below with reference to FIG. 8.

FIG. 8 is a flowchart showing the processing to be executed by the MR presentation system according to the second embodiment of the present invention.

Note that the processing in FIG. 8 is implemented when a CPU of the PC 1101 reads out a program stored in a ROM and executes the readout program.

In step S501, a real image input unit 1111 inputs a real image. Note that the real image input unit 1111 senses and inputs an image using the image sensing device 1105, and stores that sensed image in a real image memory 1121 as a real image.

In step S502, a position and orientation detection unit 1112 detects the position and orientation information of the image sensing device 1105 and that of the pointing device 1102 using the position and orientation sensors 1108 and 1109. The unit 1112 stores these information in the memory 1107 as image sensing device position and orientation information 1122 and the pointing device position and orientation information 1123.

In step S503, a virtual image is updated. In this case, the position and orientation of the virtual pointing device data 1126 in the virtual object image data 1125 are updated based on the pointing device position and orientation information 1123. Then, the virtual pointing device data 1126 is laid out to extend from the tip of the pointing device 1102.

Note that the second embodiment does not mention about a practical arrangement for changing the position and orientation of the virtual object image data 1125. However, assume that an arrangement for manipulating the virtual object image data 1125 is normally arranged as in a general VR (virtual reality) or a MR system to allow the user to manipulate the virtual object image data 1125.

In step S504, the switch detection unit 1118 detects the pressing state (ON/OFF) of the switch 401 of the pointing device 1102 to check if the switch 401 is pressed (ON). If the switch 401 is ON (YES in step S504), the process advances to step S505. On the other hand, if the switch 401 is OFF (NO in step S504), the process advances to step S510.

In step S510, the real pointing device control unit 1117 turns off the laser pointer (real laser pointer) 402 of the pointing device 1102 to turn off emission of the laser pointer 402. In step S511, the display of the virtual pointing device data 1126 on the HMD 1104 is set to OFF (if it is already OFF, nothing is done). Note that it is easy for the prior art to dynamically change the non-display/display state of a virtual object (in this case, the virtual pointing device) in a virtual image.

If it is determined in step S504 that the switch 401 of the pointing device 1102 is ON (YES in step S504), a virtual object existence determination unit 1115 checks in step S505 if the virtual object image data 1125 exists at the pointing destination of the pointing device 1102.

The virtual object existence determination unit 1115 can determine the pointing direction of the pointing device 1102 using the pointing device position and orientation information 1123. Also, since the position and orientation of the virtual object image data 1125 are known, it is easy for the prior art to check if the virtual object exists at the pointing destination of the pointing device 1102.

If it is determined in step S505 that no virtual object exists (NO in step S505), the process advances to step S506. In step S506, the real pointing device control unit 1117 turns on the laser pointer (real laser pointer) 402 of the pointing device 1102 to control the laser pointer 402 to emit a laser beam. In step S507, the display of the virtual pointing device data 1126 on the HMD 1104 is set to OFF (if it is already OFF, nothing is done).

On the other hand, if it is determined in step S505 that a virtual object exists (YES in step S505), the process advances to step S508. In step S508, a virtual pointing device generation unit 1116 renders a laser beam CG based on the virtual pointing device data 1126 on the memory 1107. The virtual pointing device generation unit 1116 sets the display of the virtual pointing device data 1126 on the HMD 1104 to ON (if it is already ON, nothing is done).

At this time, the virtual pointing device data 1126 must intersect a virtual object indicated by the virtual object image data 1125. In this case, the virtual pointing device generation unit 1116 executes processing for erasing the display of the virtual pointing device data 1126 after a position where the virtual pointing device data 1126 intersects the virtual object. The method of erasing the display after the intersection can be implemented by a state-of-the-art technique.

Note that the virtual pointing device generation unit 1116 may display, for example, an index like the pointing mark CG 1204 in FIG. 9 at the intersection of the virtual pointing device data 1126 and virtual object. This to allow easy recognition of the pointing position and, for example, a circle with an appropriate radius is rendered. Only a CG of such index may be rendered without rendering any laser beam CG based on the virtual pointing device data 1126.

In step S509, the real pointing device control unit 1117 turns off the laser pointer (real laser pointer) 402 in the pointing device 1102 to stop emission of the laser pointer 402.

In step S512, a virtual image generation unit 1113 stores a virtual image including the virtual object image data 1125 and the virtual pointing device data 1126 in a virtual image memory 1124 based on the aforementioned processing result. The virtual image generation unit 1113 renders the virtual image viewed from the position and orientation of the image sensing device indicated by the image sensing device position and orientation information 1122, and stores it in the virtual image memory 1124. This processing is the same as that executed in the conventional MR presentation system.

In step S513, an image display unit 1114 displays an MR image obtained by combining the real image stored in the real image memory 1121 and the virtual image stored in the virtual image memory 1124 on a display unit (in this case, the HMD 1104). This processing is the same as that executed in the conventional MR presentation system.

It is then checked in step S514 if the processing is to end. If the processing is to end (YES in step S514), the MR image presentation processing ends. On the other hand, if the processing is not to end (NO in step S514), the process returns to step S501. As a result, the MR image can be presented as a continuous moving image.

When the HMD 1104 allows stereoscopic display, stereoscopic images can be generated by repeating the processing in FIG. 8 for the viewpoints of the right and left eyes (in this case, the image sensing device 1105 is required for each of right and left displays). Of course, depending on the arrangements, two or more image sensing devices may be used. As the processing for the arrangement using a plurality of image sensing devices, the processing in FIG. 8 is executed for each image sensing device.

When the display of the virtual pointing device data 1126 on the HMD 1104 is set to OFF in steps S507 and S511, it need not be completely set to OFF. For example, the laser beam CG based on the virtual pointing device data 1126 may have a display length shortened to a predetermined length when it is displayed. This predetermined length is not particularly limited as long as the virtual pointing device data 1126 does not reach the virtual object.

That is, in the second embodiment, when no virtual object exists in the pointing direction of the virtual pointing device, the index indicating the virtual pointing position is displayed to have a display pattern different from that of the index indicating the virtual pointing position when a virtual object exists.

In this way, when the pointing device ceases to point to the virtual object, a situation in which the laser beam CG based on the virtual pointing device data 1126, which was displayed in the pointing direction so far, suddenly disappears, and makes it hard for the user to determine the pointing direction for a moment can be avoided.

As described above, according to the second embodiment, in addition to the effects described in the first embodiment, pointing by consistent operations can be presented to both the real object and virtual object more effectively.

Note that an arrangement that arbitrarily combines those of the first and second embodiments can be implemented depending on use applications and purposes.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2006-210255 filed on Aug. 1, 2006, which is hereby incorporated by reference herein in its entirety.

What is claimed is:

1. A mixed reality presentation apparatus which combines a virtual image with a real image sensed by an image sensing device, and presents a combined image, comprising:
first measurement means for measuring a pointing position of a pointing device based on position and orientation information of the pointing device;
second measurement means for measuring the pointing position based on a pointing position in a sensed image obtained by sensing the pointing position of the pointing device by the image sensing device, and position and orientation information of the image sensing device;
real pointing position measurement means for measuring a real pointing position of the pointing device based on the measurement results of said first measurement means and said second measurement means;
generation means for generating a virtual pointing device that points to a virtual image to be combined with the real image using the same reference as a reference used to measure the real pointing position; and
virtual pointing position measurement means for measuring a virtual pointing position of the virtual pointing device.

2. The apparatus according to claim 1, further comprising display means for combining and displaying the real image and the virtual image based on the measurement results of said real pointing position measurement means and said virtual pointing position measurement means.

3. The apparatus according to claim 2, wherein said display means further displays an index indicating the virtual pointing position on the virtual image.

4. The apparatus according to claim 1, wherein said second measurement means measures the pointing position based on pointing positions in sensed images obtained by sensing the pointing position of the pointing device by a plurality of image sensing devices and a plurality of position and orientation information of the plurality of image sensing devices.

5. The apparatus according to claim 1, further comprising calculation means for acquiring position information indicating the real pointing position and position information indicating the virtual pointing position and calculating a distance between the real pointing position and the virtual pointing position.

6. The apparatus according to claim 1, further comprising:
determination means for determining whether or not the virtual image exists in a pointing direction of the virtual pointing device; and
control means for controlling driving of the pointing device and display of an index indicating the virtual pointing position based on the determination result of said determination means.

7. The apparatus according to claim 6, wherein when the virtual image exists in the pointing direction of the virtual pointing device as a result of determination of said determination means, the driving of the pointing device is stopped, and the index indicating the virtual pointing position is displayed on the virtual image.

8. The apparatus according to claim 6, wherein when the virtual image does not exist in the pointing direction of the virtual pointing device as a result of determination of said determination means, the pointing device is driven, and the index indicating the virtual pointing position is inhibited from being displayed.

9. The apparatus according to claim 6, wherein when the virtual image does not exist in the pointing direction of the virtual pointing device as a result of determination of said determination means, the pointing device is driven, and the index indicating the virtual pointing position is displayed to have a display pattern different from a display pattern of the index indicating the virtual pointing position when the virtual image exists in the pointing direction of the virtual pointing device.

10. A method of controlling a mixed reality presentation apparatus which combines a virtual image with a real image sensed by an image sensing device, and presents a combined image, said method comprising:
a first measurement step of measuring a pointing position of a pointing device based on position and orientation information of the pointing device;
a second measurement step of measuring the pointing position based on a pointing position in a sensed image obtained by sensing the pointing position of the pointing device by the image sensing device, and position and orientation information of the image sensing device;
a real pointing position measurement step of measuring a real pointing position of the pointing device based on the measurement results in the first measurement step and the second measurement step;
a generation step of generating a virtual pointing device that points to a virtual image to be combined with the real image using the same reference as a reference used to measure the real pointing position; and
a virtual pointing position measurement step of measuring a virtual pointing position of the virtual pointing device.

11. A computer program which is stored in a computer-readable medium to make a computer execute control of a mixed reality presentation apparatus that combines a virtual image with a real image sensed by an image sensing device and presents a combined image, said computer program making the computer execute:
a first measurement step of measuring a pointing position of a pointing device based on position and orientation information of the pointing device;
a second measurement step of measuring the pointing position based on a pointing position in a sensed image obtained by sensing the pointing position of the pointing device by the image sensing device, and position and orientation information of the image sensing device;
a real pointing position measurement step of measuring a real pointing position of the pointing device based on the measurement results in the first measurement step and the second measurement step;
a generation step of generating a virtual pointing device that points to a virtual image to be combined with the real image using the same reference as a reference used to measure the real pointing position; and
a virtual pointing position measurement step of measuring a virtual pointing position of the virtual pointing device.

12. A mixed reality presentation apparatus which combines a virtual image with a real image sensed by an image sensing device, and presents a combined image, comprising:
measurement means for measuring a position and orientation of a pointing device which has a light-emitting unit used to point to a three-dimensional position;
determination means for determining based on the position and orientation measured by said measurement means whether or not the pointing device points to a virtual object; and
control means for controlling the light-emitting unit of the pointing device based on the determination result of said determination means.

13. The apparatus according to claim 12, wherein the pointing device further comprises:
a switch for controlling driving of itself; and
display control means for controlling display of a virtual pointing device based on the determination result of said determination means, and
said determination means further determines whether the switch is ON or OFF.

14. The apparatus according to claim 13, wherein
1) when the switch is OFF as a result of determination by said determination means, said control means sets the driving of the pointing device to OFF, and said display control means sets the display of the virtual pointing device to OFF,
2) when the switch is ON and the pointing device points to the virtual object as a result of determination by said determination means, said display control means sets the display of the virtual pointing device to ON, and said control means sets the driving of the pointing device to OFF, and
3) when the switch is ON and the pointing device does not point to the virtual object as a result of determination by said determination means, said control means sets the driving of the pointing device to ON, and said display control means sets the display of the virtual pointing device to OFF.

15. A method of controlling a mixed reality presentation apparatus which combines a virtual image with a real image sensed by an image sensing device, and presents a combined image, said method comprising:
a measurement step of measuring a position and orientation of a pointing device which has a light-emitting unit used to point to a three-dimensional position;
a determination step of determining based on the position and orientation measured in the measurement step whether or not the pointing device points to a virtual object; and
a control step of controlling the light-emitting unit of the pointing device based on the determination result in the determination step.

16. A computer program, stored in a computer-readable medium, for making a computer execute control of a mixed reality presentation apparatus which combines a virtual image with a real image sensed by an image sensing device, and presents a combined image, said computer program making the computer execute:
a measurement step of measuring a position and orientation of a pointing device which has a light-emitting unit used to point to a three-dimensional position;
a determination step of determining based on the position and orientation measured in the measurement step whether or not the pointing device points to a virtual object; and
a control step of controlling the light-emitting unit of the pointing device based on the determination result in the determination step.
